(19) United States
(12) Patent Application Publication
(10) Pub. No.: US 2021/0345457 A1
(43) Pub. Date: Nov. 4, 2021

(54) HEATER AND ARTICLE EQUIPPED WITH HEATER

(71) Applicant: NITTO DENKO CORPORATION, Ibaraki-shi, Osaka (JP)

(72) Inventors: Tetsuro HORI, Osaka (JP); Shu SASAKI, Osaka (JP); Naoko KATO, Osaka (JP); Toshihiro TSURUSAWA, Osaka (JP); Kyotaro YAMADA, Osaka (JP)

(73) Assignee: NITTO DENKO CORPORATION, Ibaraki-shi, Osaka (JP)

(21) Appl. No.: 17/273,493

(22) PCT Filed: Sep. 6, 2019
(86) PCT No.: PCT/JP2019/035230

§ 371 Date: Mar. 4, 2021

(30) Foreign Application Priority Data
Sep. 14, 2018 (JP) 2018-172291

(51) Int. Cl. H05B 3/26; H05B 3/03; H05B 3/16

(52) U.S. Cl. CPC H05B 3/265; H05B 2203/013; H05B 3/16; H05B 3/03

(57) ABSTRACT

A heater (1a) includes: a substrate (10); a heat-generation layer (20) that is a conductive metal oxide layer (22); a pair of power supply electrodes (30); and a pressure-sensitive adhesive bonding laminate (40). The substrate (10) is formed of an organic polymer. The heat-generation layer (20) is disposed in contact with the substrate (10) in the thickness direction of the substrate (10). The pair of power supply electrodes (30) are electrically connected to the heat-generation layer (20). The pressure-sensitive adhesive bonding laminate (40) has a pressure-sensitive adhesive surface (41a) used for pressure-sensitive adhesive bonding with an adherend. In the pressure-sensitive adhesive bonding laminate (40), a plurality of pressure-sensitive adhesive layers (41, 42) and at least one support (45) for the plurality of pressure-sensitive adhesive layers are alternately laminated between the pressure-sensitive adhesive surface (41a) and the heat-generating layer (20).

### TECHNICAL FIELD

The present invention relates to a heater and an article equipped with a heater (also referred to as “heater-equipped article” hereinafter).

### BACKGROUND ART

Heaters provided with a conductive film formed of a metal oxide have conventionally been known.

For example, Patent Literature 1 discloses a heat-generating resin substrate that includes a resin substrate, a transparent conductive film formed of a metal oxide, a pair of electrodes, and a power source. The transparent conductive film is formed on a surface of the resin substrate and generates heat when electric power is supplied thereto. A buffer layer is provided between the resin substrate and the transparent conductive film in order to buffer the difference in thermal expansion and thermal contraction between them. The buffer layer is formed of one or more compounds selected from the group consisting of titanium oxide, silicon oxide, niobium oxide, and silicon nitride. The heat-generating resin substrate can be used as a vehicle window.

### CITATION LIST

### Patent Literatures

Patent Literature 1: JP 2008-41343 A

### SUMMARY OF INVENTION

### Technical Problem

Patent Literature 1 does not describe attaching the heat-generating resin substrate to an adherend using a pressure-sensitive adhesive material. In such a case, expansion and contraction of the adherend caused by a change in environmental conditions such as the temperature and the humidity have some effects on the conductive film. However, in Patent Literature 1, such effects had not been examined.

In light of the foregoing, the present invention provides a heater that includes a metal oxide layer as a heat-generating layer and is adapted such that, when the heater is attached to an adherend using a pressure-sensitive adhesive material, the heat-generating layer is unlikely to fracture even if the adherend expands or contracts owing to a change in environmental conditions. The present invention also provides a heater-equipped article obtained by attaching such a heater to an adherend using a pressure-sensitive adhesive material.

### Solution to Problem

The present invention provides a heater including: a substrate that is formed of an organic polymer; a heat-generating layer that is disposed in contact with the substrate in a thickness direction of the substrate, the heat-generating layer being a conductive metal oxide layer; a pair of power supply electrodes that are electrically connected to the heat-generating layer; and a pressure-sensitive adhesive bonding laminate that has a pressure-sensitive adhesive surface used for pressure-sensitive adhesive bonding with an adherend and in which a plurality of pressure-sensitive adhesive layers and at least one support for the plurality of pressure-sensitive adhesive layers are alternately laminated between the pressure-sensitive adhesive surface and the heat-generating layer in the thickness direction of the substrate.

The present invention also provides a heater-equipped article including: an adherend; and the above-described heater attached to the adherend with the pressure-sensitive adhesive surface being in contact with the adherend.

### Advantageous Effects of Invention

According to the above-described heater, the heat-generating layer is unlikely to fracture even if the adherend expands or contracts owing to a change in environmental conditions.

### BRIEF DESCRIPTION OF DRAWINGS

FIG. 1 is a cross-sectional view showing an example of the heater according to the present invention.

FIG. 2 is a cross-sectional view showing an example of a heater equipped article.

FIG. 3 is a cross-sectional view showing another example of the heater according to the present invention.

FIG. 4 is a cross-sectional view showing still another example of the heater according to the present invention.

### DESCRIPTION OF EMBODIMENTS

It is conceivable that a heater produced by forming a conductive metal oxide layer and a pair of electrodes on a substrate formed of an organic polymer is attached to an adherend using a pressure-sensitive adhesive material. The heater can be attached to various types of adherends in this manner. Such a heater can be used to prevent snow accretion or fogging.

The adherend having the heater attached thereto may be exposed to a high temperature or high humidity environment in, for example, summer or the rainy season depending on the use of the adherend. In this case, expansion or contraction of members constituting the adherend having the heater attached thereto may be caused owing to the difference in coefficient of thermal expansion (CTE) or in coefficient of hygroscopic expansion (CHE) between these members. The heat-generating layer, which is a conductive metal oxide layer, generally has a low tensile strength. Accordingly, the heat-generating layer may fracture when it is subjected to a tensile stress generated by the expansion or contraction of the members of the adherend with the heater attached thereto. In order to provide a heater that is attachable to various types of adherends, the heater is desirably configured such that a heat-generating layer is less susceptible to effects caused by the expansion or contraction of the adherend due to a change in environmental conditions. One possible method to prevent the heat-generating layer from being subjected to the effects of the expansion or contraction of the adherend due to a change in environmental conditions is, for example, to increase the thickness of a pressure-sensitive adhesive layer.

Meanwhile, the inventors of the present invention have found that a thick pressure-sensitive adhesive layer may easily peel off from an adherend. For example, when an adherend is made of a hygroscopic material such as polycarbonate, a thick pressure-sensitive adhesive layer may peel off from the adherend owing to water vapor emitted from the adherend. With consideration given to the above, the inventors conducted in-depth studies to establish a technique for rendering a heat-generating layer unlikely to fracture even if an adherend expands or contracts owing to a change in environmental conditions and also rendering a pressure-sensitive adhesive layer unlikely to peel off from the adherend. After much trial and error, the inventors have developed a heater that includes a predetermined laminate for pressure-sensitive adhesive bonding.

Hereinafter, embodiments of the present invention will be described with reference to the drawings. The following embodiments describe merely illustrative implementation of the present invention, and the present invention is not limited to the following embodiments.

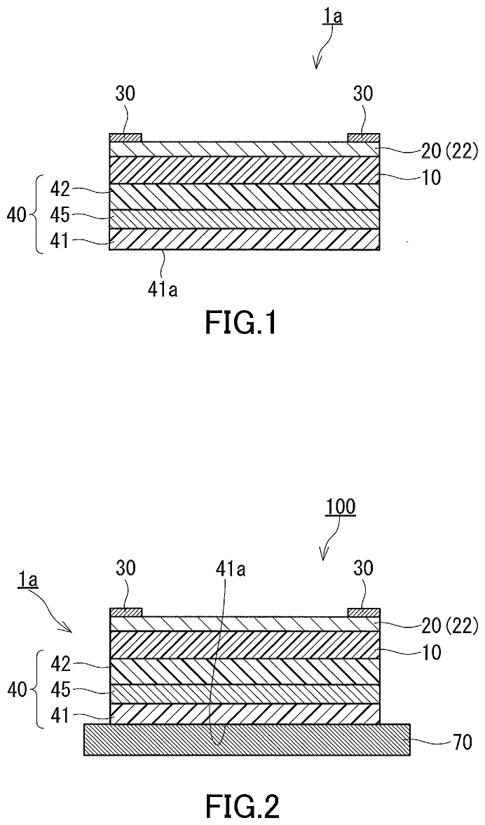

As shown in FIG. 1, a heater 1a includes a substrate 10, a heat-generating layer 20, which is a conductive metal oxide layer 22, a pair of power supply electrodes 30, and a pressure-sensitive adhesive bonding laminate 40. The substrate 10 is formed of an organic polymer. This makes it easier to reduce the weight of the heater 1a. The heat-generating layer 20 is disposed in contact with the substrate 10 in the thickness direction of the substrate 10. Typically, the substrate 10 is a member for providing a surface on which the heat-generating layer 20 is formed. The pair of power supply electrodes 30 are electrically connected to the heat-generating layer 20. The pair of power supply electrodes 30 can be connected to a power source (not shown). In the present specification, the pair of power supply electrodes 30 refer to a pair made up of a positive electrode and a negative electrode. When one of the pair of power supply electrodes 30 serves as a positive electrode, the other one of the pair of power supply electrodes 30 serves as a negative electrode. Electric power from the power source is supplied to the heat-generating layer 20 by the pair of power supply electrodes 30, whereby the heat-generating layer 20 generates heat. As a result, snow accretion or fogging can be prevented. The pressure-sensitive adhesive bonding laminate 40 has a pressure-sensitive adhesive surface 41a used for pressure-sensitive adhesive bonding with an adherend. The heater 1a is attached to an adherend by pressing the pressure-sensitive adhesive surface 41a against the adherend. In the pressure-sensitive adhesive bonding laminate 40, a plurality of pressure-sensitive adhesive layers 41 and 42 and at least one support 45 for the plurality of pressure-sensitive adhesive layers are alternately laminated between the pressure-sensitive adhesive surface 41a and the heat-generating layer 20 in the thickness direction of the substrate 10.

A heater-equipped article can be provided using the heater 1a. As shown in FIG. 2, a heater-equipped article 100 includes an adherend 70 and the heater 1a. The heater 1a is attached to the adherend 70 with the pressure-sensitive adhesive surface 41a being in contact with the adherend 70.

The pressure-sensitive adhesive bonding laminate 40 includes the plurality of pressure-sensitive adhesive layers 41 and 42. Accordingly, even when, of the pressure-sensitive adhesive layers included in the pressure-sensitive adhesive bonding laminate 40, the one to be in contact with the adherend 70 has a small thickness, the sum of the thicknesses of the pressure-sensitive adhesive layers included in the pressure-sensitive adhesive bonding laminate 40 tends to be large. Accordingly, in the heater 1a, the heat-generating layer 20 is less susceptible to effects caused by expansion or contraction of the adherend 70 due to a change in environmental conditions and thus is unlikely to fracture. In addition, the pressure-sensitive adhesive layers in the pressure-sensitive adhesive bonding laminate 40 can be prevented from peeling off from the adherend 70 owing to the effect of water vapor or the like emitted from the adherend 70.

The plurality of pressure-sensitive adhesive layers in the pressure-sensitive adhesive bonding laminate 40 include, for example, a first pressure-sensitive adhesive layer 41 that forms the pressure-sensitive adhesive surface 41a. The first pressure-sensitive adhesive layer 41 has a thickness of 150 μm or less, for example. This more reliably prevents the first pressure-sensitive adhesive layer 41 from peeling off from the adherend 70 owing to the effect of water vapor or the like emitted from the adherend 70.

The thickness of the first pressure-sensitive adhesive layer 41 may be 140 μm or less, 130 μm or less, or 120 μm or less. The thickness of the first pressure-sensitive adhesive layer 41 is 5 μm or more, for example. The thickness of the first pressure-sensitive adhesive layer 41 may be 15 μm or more, or 25 μm or more.

The plurality of pressure-sensitive adhesive layers in the pressure-sensitive adhesive bonding laminate 40 typically include at least one second pressure-sensitive adhesive layer 42. The second pressure-sensitive adhesive layer 42 is disposed spaced apart from the pressure-sensitive adhesive surface 41a in the thickness direction of the substrate 10. For example, the second pressure-sensitive adhesive layer 42 has a thickness of 25 μm or more, and the sum of the thicknesses of the plurality of pressure-sensitive adhesive layers in the pressure-sensitive adhesive bonding laminate 40 is 150 μm or more. This more reliably prevents the heat-generating layer 20 from being subjected to effects caused by expansion or contraction of the adherend 70 due to a change in environmental conditions, whereby the heat-generating layer 20 is more reliably prevented from fracturing.

The thickness of the second pressure-sensitive adhesive layer 42 is 500 μm or less, for example. The thickness of the second pressure-sensitive adhesive layer 42 may be 300 μm or less, or 200 μm or less. This makes it easier to reduce the thickness of the heater 1a.

The pressure-sensitive adhesive material used to form the plurality of pressure-sensitive adhesive layers in the pressure-sensitive adhesive bonding laminate 40 is not limited to particular one as long as the heater 1a can be appropriately attached to the adherend 70. The pressure-sensitive adhesive material may be, for example, a rubber-based pressure-sensitive adhesive material, an acrylic pressure-sensitive adhesive material, a silicone-based pressure-sensitive adhesive material, or a urethane-based pressure-sensitive adhesive material. In the pressure-sensitive adhesive bonding laminate 40, the pressure-sensitive adhesive material that forms the first pressure-sensitive adhesive layer 41 and the pressure-sensitive adhesive material that forms the second pressure-sensitive adhesive layer 42 may be of the same type or different types.

The support 45 is not limited to particular one as long as it can prevent the pressure-sensitive adhesive layers from being in contact with each other. Desirably, the in-plane dimensional change rate Rs represented by the following formula (1) of the support 45 is 1.0% or less. In this case, the heat-generating layer 20 is more reliably prevented from being subjected to effects caused by expansion or contraction of the adherend 70 due to a change in environmental conditions, whereby the heat-generating layer 20 is more reliably prevented from fracturing. In the formula (1), S_{25,50} denotes an in-plane dimension of the support 45 in an environment at 25° C. with a relative humidity of 50%. S_{80,80} denotes an in-plane dimension of the support 45 in an environment at 80° C. with a relative humidity of 80%.

In-plane dimensional change rate Rs=100×|S_{80,80}−S_{25,50}|/S_{25,50} (1)

The in-plane dimensional change rate Rs is typically determined in the state where the support 45 is not constrained. The in-plane dimensional change rate Rs can be determined according to a method including the following steps (a) to (d), for example.
(a) Test pieces formed of the same material as that of the support 45 and having the same thickness as the support 45 are prepared.
(b) One of the test pieces prepared in the step (a) is placed in an environment at 25° C. with a relative humidity of 50% for a predetermined period of time, and thereafter, an in-plane dimension of the test piece in a particular direction is measured to determine S_{25,50}.
(c) The other test piece prepared in the step (a) is placed in an environment at 80° C. with a relative humidity of 80% for a predetermined period of time, and thereafter, an in-plane dimension of the test piece in the particular direction is measured to determine S_{80,80}.
(d) The in-plane dimensional change rate Rs is determined as per the formula (1) using the measurement results obtained in the steps (b) and (c).

Typically, the material of the support 45 determines the in-plane dimensional change rate Rs. For example, the heater 1a is peeled off from the adherend 70 in the heater-equipped article 100. Next, the first pressure-sensitive adhesive layer 41 is peeled off from the heater 1a to expose one principal surface of the support 45. Then, the material of the support 45 is specified according to a method such as Fourier-transform infrared spectroscopy (FT-IR). When the in-plane dimensional change rate of a support made of the thus-specified material is known, the in-plane dimensional change rate of the support 45 may be determined based on the known information.

The in-plane dimensional change rate Rs of the support 45 is desirably 0.9% or less, more desirably 0.7% or less, and still desirably 0.5% or less.

The support 45 has a thickness of 25 μm or more, for example. This makes it easier to appropriately form the plurality of pressure-sensitive adhesive layers in the pressure-sensitive adhesive bonding laminate 40.

The thickness of the support 45 may be 35 μm or more, or 45 μm or more. The thickness of the support 45 is 500 μm or less, for example. This makes it easier to reduce the thickness of the heater 1a, thereby allowing the heater 1a to be easily bent. The thickness of the support 45 may be 250 μm or less, or 150 μm or less.

The material of the support 45 is not limited to particular one, and may be, for example, an organic polymer material such as a polyethylene terephthalate, a polyethylene naphthalate, a polyimide, a polycarbonate, or a polymethyl methacrylate, or may be an inorganic material such as a thin sheet glass or a super thin sheet glass.

The pressure-sensitive adhesive bonding laminate 40 has a thickness of 1 mm or less, for example. In this case, the thickness of the heater 1a can be reduced easily, which allows the heater 1a to be easily bent.

The thicknesses of the substrate 10, the heat-generating layer 20, the pressure-sensitive adhesive bonding laminate 40, the support 45, and the respective pressure-sensitive adhesive layers in the pressure-sensitive adhesive bonding laminate 40 can be determined, for example, through observation of a cross section of the heater 1a with a microscope such as an optical microscope or a scanning electron microscope (SEM). The thicknesses of the substrate 10 and the support 45 may be determined by measuring them using an instrument such as a micrometer prior to the production of the heater 1a. When the substrate 10, the heat-generating layer 20, the pressure-sensitive adhesive bonding laminate 40, the support 45, and the respective pressure-sensitive adhesive layers in the pressure-sensitive adhesive bonding laminate 40 exhibit a wide range of in-plane thickness variation, the thickness of each of them may be determined by measuring thicknesses at randomly selected ten or more spots and then calculating the arithmetic mean of the thus-measured values.

The conductive metal oxide layer 22 is, for example, a crystalline film, and has a thickness of, for example, 20 nm or more. This allows the sheet resistance of the conductive metal oxide layer 22 to be kept low, whereby the heater 1a can exhibit desired heating performance. The thickness of the conductive metal oxide layer 22 is desirably 30 nm or more, and more desirably 40 nm or more. The thickness of the conductive metal oxide layer 22 is 200 nm or less, for example. This renders the conductive metal oxide layer 22 unlikely to crack.

The conductive metal oxide layer 22 contains, for example, indium oxide as a main component. The material forming the conductive metal oxide layer 22 is desirably indium tin oxide (ITO). In this case, the content of tin oxide in ITO is, for example, from 4 to 14 mass %, and desirably from 5 to 13 mass %. ITO forming the conductive metal oxide layer 22 desirably has a crystal structure. This is advantageous from the viewpoint of keeping the specific resistance of the conductive metal oxide layer 22 low. The term “main component” as used herein refers to a component whose content on a mass basis is the highest.

The organic polymer forming the substrate 10 is at least one selected from the group consisting of polyethylene terephthalates, polyethylene naphthalates, polyimides, polycarbonates, polyether ether ketones, and aromatic polyamides, for example.

The thickness of the substrate 10 is not limited to a particular thickness.

From the viewpoint of favorable transparency, favorable strength, and ease of handling, the thickness of the substrate 10 is from 10 μm to 200 μm, for example. The thickness of the substrate 10 may be from 20 μm to 180 μm, or may be from 30 μm to 160 μm.

The substrate 10 may include a functional layer such as a hard coat layer, a stress buffer layer, or an optical adjustment layer. Each of these functional layers constitutes, for example, one principal surface of the substrate 10. Each of these functional layers can serve as a base of the heat-generating layer 20.

For example, in the thickness direction of the substrate 10, the substrate 10 is located closer to the pressure-sensitive adhesive bonding laminate 40 than the heat-generating layer 20 is. In this case, since the heat-generating layer 20 is either on or near the surface of the heater 1a, the surface temperature of the heater 1a tends to rise with a small amount of electric power.

The pair of power supply electrodes 30 contain a metal as a main component and have a thickness of, for example, 1 μm or more. This allows the heater 1a to easily exhibit desired heating performance. The pair of power supply electrodes 30 are much thicker than electrodes formed on a transparent conductive film used in display devices such as a touch panel. The thickness of the power supply electrodes 30 may be 2 μm or more, 3 μm or more, or 5 μm or more. The thickness of the power supply electrodes 30 is, for example, 5 mm or less, and may be 1 mm or less, or 700 μm or less.

The material forming the adherend 70 in the heater-equipped article 100 is not limited to particular one, and may be, for example, an organic polymer material such as a polycarbonate, a polymethyl methacrylate resin, or a polypropylene, a metal material such as stainless steel, or an inorganic material such as glass.

The heater 1a has, for example, an average transmittance of 70% or more for light having a wavelength from 400 to 1200 nm. Thus, the heater 1a has favorable transparency for visible light, and this makes it easier to visually observe the adherend 70 or the state in a space behind the adherend 70. In addition, the heater 1a can transmit near-infrared light used for communication or sensing.

The conductive metal oxide layer 22 is obtained by, for example, performing sputtering using a predetermined target material to form a thin film derived from the target material on one principal surface of the substrate 10. The thin film derived from the target material is formed on one principal surface of the substrate 10 desirably by high magnetic field DC magnetron sputtering. In this case, the conductive metal oxide layer 22 can be formed at low temperatures. Accordingly, for example, even when the heat resistant temperature of the substrate 10 is not high, the conductive metal oxide layer 22 can be formed on one principal surface of the substrate 10. In addition, defects are less likely to occur in the conductive metal oxide layer 22, and a low internal stress of the conductive metal oxide layer 22 can be achieved more easily. Also, by adjusting the conditions for sputtering, a thin film that is desirable as the conductive metal oxide layer 22 can be formed easily. For example, by adjusting the intensity of the horizontal magnetic field on a surface of a target material to a predetermined value in high magnetic field DC magnetron sputtering, the conductive metal oxide layer 22 desirable in terms of specific resistance can be obtained easily.

The thin film formed on one principal surface of the substrate 10 is subjected to annealing, when necessary. For example, the thin film is annealed by being placed in the air at 120° C. to 150° C. for 1 to 3 hours. This facilitates crystallization of the thin film, whereby the crystalline conductive metal oxide layer 22 is formed advantageously. When the temperature of the environment in which the annealing treatment of the thin film is performed and the time period for performing the annealing treatment are within the above-described ranges, the heat resistant temperature of the substrate 10 need not necessarily be high, and many types of organic polymers can be used as the material of the substrate 10. In addition, defects are less likely to occur in the conductive metal oxide layer 22, and a low internal stress of the conductive metal oxide layer 22 can be achieved more easily. By adjusting the conditions for the annealing treatment, the conductive metal oxide layer 22 desirable in terms of specific resistance can be obtained easily.

Instead of sputtering, a method such as vacuum deposition or ion plating may be used to form the conductive metal oxide layer 22.

The pair of power supply electrodes 30 are formed in the following manner, for example. A metal film having a thickness of 500 nm or less is formed on a principal surface of the conductive metal oxide layer 22, by, for example, a dry process such as chemical vapor deposition (CVD) or physical vapor deposition (PVD). Then, the metal film is subjected to, for example, a wet process such as plating to increase the thickness of the metal film to 1 μm or more. Next, masking films are placed on portions of the metal film to be processed into the power supply electrodes 30, and an unnecessary portion of the metal film is removed by etching. Thereafter, the masking films are removed. As a result, the metal film remains on portions of the conductive metal oxide layer 22 having been covered with the masking films, whereby the power supply electrodes 30 are formed. Alternatively, the pair of power supply electrodes 30 may be formed in the following manner, for example. A metal film having a thickness of 500 nm or less is formed on a principal surface of the conductive metal oxide layer 22 by, for example, a dry process such as CVD or PVD. A masking film is placed so as to partially cover the metal film. In this state, the metal film is subjected to, for example, a wet process such as plating to increase the thickness of the metal film to 1 μm or more. Thereafter, the masking film is removed, and a portion of the metal film having been covered with the masking film is removed by etching. As a result, the metal film remains on portions of the conductive metal oxide layer 22 not having been covered with the masking film, whereby the power supply electrodes 30 are formed. Alternatively, the power supply electrodes 30 may be formed by applying a conductive ink so as to form a predetermined pattern on a principal surface of the conductive metal oxide layer 22 and then curing the applied conductive ink. The power supply electrodes 30 may be formed using solder paste.

In the above-described manner, a laminate that includes the substrate 10, the heat-generating layer 20, which is the conductive metal oxide layer 22, and the pair of power supply electrodes 30 can be produced. The heater 1a can be produced by, for example, pressing the pressure-sensitive adhesive bonding laminate 40 against a principal surface of the substrate 10 located farther from the heat-generating layer 20. The pressure-sensitive adhesive bonding laminate 40 can be produced by, for example, applying a predetermined pressure-sensitive adhesive material to one principal surface of the support 45 to form the first pressure-sensitive adhesive layer 41 and applying a predetermined pressure-sensitive adhesive material to the other principal surface of the support 45 to form the second pressure-sensitive adhesive layer 42. For example, the second pressure-sensitive adhesive layer 42 of the pressure-sensitive adhesive bonding laminate 40 is pressed against the principal surface of the substrate 10 located farther from the heat-generating layer 20.

The first pressure-sensitive adhesive layer 41 of the heater 1a may be covered with a separator (not shown), for example. In this case, the separator is peeled off to expose the pressure-sensitive adhesive surface 41a at the time of attaching the heater 1a to the adherend 70. The separator is, for example, a film made of a polyester resin such as polyethylene terephthalate (PET).

The heater 1a can be modified in various respects. For example, the heater 1a may be modified so as to include a plurality of supports 45. The number Na of the pressure-sensitive adhesive layers and the number Ns of the supports 45 in the pressure-sensitive adhesive bonding laminate 40 satisfy the relationship of Na=Ns+1. Ns is an integer of 1 or more.

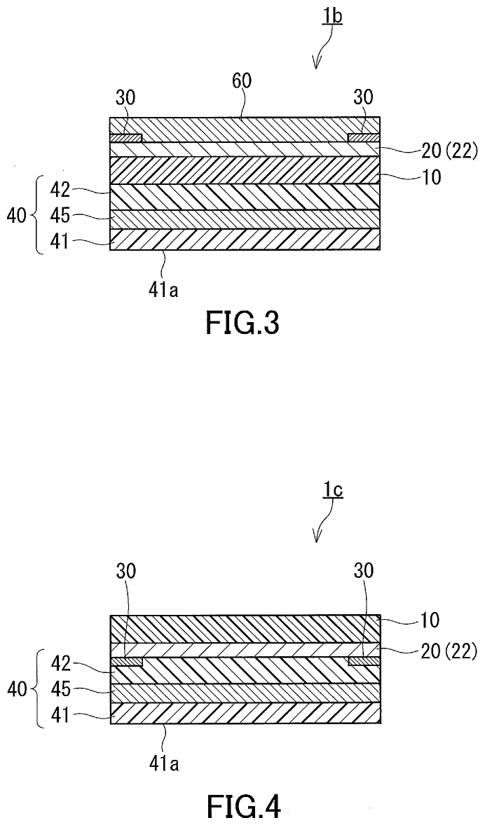

The heater 1a may be modified so as to have the configuration of a heater 1b shown in FIG. 3 or the configuration of a heater 1c shown in FIG. 4. Unless otherwise stated, the configurations of the heaters 1b and 1c are the same as the configuration of the heater 1a. Components of the heaters 1b and 1c that are the same as or correspond to those of the heater 1a are given the same reference numerals, and detailed descriptions thereof are omitted. The descriptions regarding the heater 1a also apply to the heaters 1b and 1c, unless technically incompatible.

As shown in FIG. 3, the heater 1b includes a protective layer 60. The protective layer 60 is disposed in such a manner that a conductive metal oxide layer 22 and a pair of power supply electrodes 30 are located between the protective layer 60 and a substrate 10. The protective layer 60 includes, for example, a predetermined protective film and a pressure-sensitive adhesive layer for bonding the protective film to the conductive metal oxide layer 22. The material forming the conductive metal oxide layer 22 typically has low toughness. The conductive metal oxide layer 22 is protected by the protective film 60, and this allows the heater 1b to have high impact resistance. The material of the protective film included in the protective layer 60 is not limited to particular one, and may be, for example, a synthetic resin such as a fluororesin, silicone, an acrylic resin, or a polyester. The thickness of the protective film is not limited to particular value, and is, for example, from 20 to 200 μm. This can prevent the heater 1b from having an excessively large thickness while maintaining favorable impact resistance. The pressure-sensitive adhesive layer is formed of, for example, a known pressure-sensitive adhesive material such as a rubber-based pressure-sensitive adhesive material, an acrylic pressure-sensitive adhesive material, a silicone-based pressure-sensitive adhesive material, or a urethane-based pressure-sensitive adhesive material.

As shown in FIG. 4, the heater 1c is configured such that, in the thickness direction of the substrate 10, a substrate 10 is located farther from a pressure-sensitive adhesive bonding laminate 40 than a heat-generating layer 20 is. In this case, since the substrate 10 is on or near the surface of the heater 1a, a conductive metal oxide layer 22 is protected by the substrate 10. As a result, the heater 1c tends to have high impact resistance.

### EXAMPLES

Hereinafter, the present invention will be described in more detail with reference to examples. The present invention is not limited to the following examples. First, evaluation methods and measurement methods used in the examples and comparative examples will be described.

[In-plane Dimensional Change Rate]

Rectangular test pieces were prepared from a film that is of the same type as the film used as a support for a plurality of pressure-sensitive adhesive layers in a heater according to each of the examples and comparative examples. One of the test pieces was placed in an environment at 25° C. with a relative humidity of 50% for a predetermined period of time, and thereafter, S_{25,50} was determined by measuring an in-plane dimension of the test piece in a particular direction. Next, the other test piece was placed in an environment at 80° C. with a relative humidity of 80% for a predetermined period of time, and thereafter, S_{80,80} was determined by measuring an in-plane dimension of the test piece in the particular direction. The in-plane dimensional change rate Rs of the support for the plurality of pressure-sensitive adhesive layers of the heater according to each of the examples and comparative examples was determined as per the formula (1) using the thus-obtained values of S_{25,50} and S_{80,80}. The results are shown in Table 1.

[Measurement of Thickness of Conductive Metal Oxide Layer and Thickness of Power Supply Electrodes]

The thickness of a conductive metal oxide layer (heat-generating layer) included in a film provided with the conductive metal oxide layer was measured by X-ray reflectometry using an X-ray diffractometer (Rigaku Corporation, product name: RINT 2200). Also, the X-ray diffraction pattern of the conductive metal oxide layer was obtained using the X-ray diffractometer. The X-rays used in the measurement were Cu-Kα X-rays. From the X-ray diffraction patterns obtained, it was confirmed that the conductive metal oxide layer (heat-generating layer) according to each of the examples and comparative examples had a crystal structure. Also, the thickness of each power supply electrode of the heater according to each of the examples and comparative examples was measured by measuring the height of an end portion of the power supply electrode of the heater according to each of the examples and comparative examples using a stylus surface profiler (ULVAC, Inc., product name: Dektak 8).

[Evaluation of Reliability]

Heater-equipped articles according to the respective examples and comparative examples were placed in an environment at a temperature of 80° C. with a relative humidity of 80% for 168 hours. Thereafter, whether the heaters had peeled off from adherends was examined. Then, in each of the heaters that had not peeled off from the adherends, a DC voltage of 8 V was applied to the pair of power supply electrodes, and the surface temperature of the heater was measured. Whether the heat-generating layer heating layer had fractured was determined based on the surface temperature of the heater. The heater-equipped articles according to the respective examples and comparative examples were evaluated according to the following evaluation criteria. The results are shown in Table 1.
A: The heater had not peeled off from the adherend, and the heat-generating layer had not fractured.
X: The heater had peeled off from the adherend.
Y: The heat-generating layer had fractured.

### Example 1

An ITO film was formed on one principal surface of a polyethylene naphthalate (PEN) film having a thickness of 100 μm by DC magnetron sputtering using, as a target material, indium tin oxide (ITO) containing 10 wt % tin oxide in a high magnetic field with the magnetic flux density of the horizontal magnetic field on the surface of the target material being 80 to 150 mT (millitesla) and in the presence of an inert gas. The ITO film had a thickness of 50 nm. Next, a Cu thin film having a thickness of 100 nm was formed by DC magnetron sputtering. Further, the Cu thin film was subjected to wet plating to increase the thickness of the Cu film to 20 μm. The PEN film having the ITO film and the Cu film formed thereon was annealed by being placed in the air at 150° C. for 3 hours. As a result, ITO was crystallized, whereby a conductive metal oxide layer was formed.

Next, a strip-shaped section was cut out from the PEN film having the ITO film and the Cu film formed thereon. Then, the ITO film and the Cu film were partially covered with a masking film in such a manner that a pair of end portions of the conductive metal oxide layer facing each other were covered. The pair of end portions each had a width of 2 mm. Subsequently, the PEN film having the ITO film and the Cu film formed thereon was immersed in a chemical solution with which only the Cu film can be etched, whereby the Cu film was partially removed to expose the ITO film. Next, the masking film was removed, whereby a pair of power supply electrodes were formed at portions corresponding to the pair of end portions of the conductive metal oxide layer, which is the ITO film.

A first pressure-sensitive adhesive layer was formed by applying a pressure-sensitive adhesive material (Nitto Denko Corporation, product name: LUCIACS) to one principal surface of a polyethylene terephthalate (PET) film having a thickness of 125 μm. The thickness of the first pressure-sensitive adhesive layer was set to 100 μm by adjusting the pressure-sensitive adhesive material. Further, a second pressure-sensitive adhesive layer was formed by applying a pressure-sensitive adhesive material (Nitto Denko Corporation, product name: LUCIACS) to the other principal surface of the PET film. The thickness of the second pressure-sensitive adhesive layer was set to 150 μm by adjusting the pressure-sensitive adhesive material. In this manner, a pressure-sensitive adhesive bonding laminate according to Example 1 was produced.

The pressure-sensitive adhesive bonding laminate according to Example 1 was bonded through pressure-sensitive adhesive bonding to the film provided with the conductive metal oxide layer and having the pair of power supply electrodes formed thereon by pressing the second pressure-sensitive adhesive layer of the pressure-sensitive adhesive bonding laminate against a principal surface of the film on the side opposite to the conductive metal oxide layer. Thus, a heater according to Example 1 was obtained.

The first pressure-sensitive adhesive layer of the heater according to Example 1 was pressed against a surface of a polycarbonate (PC) plate having a thickness of 2 mm, thereby attaching the heater according to Example 1 to the PC plate serving as an adherend. In this manner, a heater-equipped article according to Example 1 was obtained.

### Example 2

A pressure-sensitive adhesive bonding laminate according to Example 2 was produced in the same manner as in Example 1, except that, in the production of the pressure-sensitive adhesive bonding laminate, the thickness of a second pressure-sensitive adhesive layer was set to 100 μm by adjusting the pressure-sensitive adhesive material. A heater according to Example 2 was produced in the same manner as in Example 1, except that the pressure-sensitive adhesive bonding laminate according to Example 2 was used instead of the pressure-sensitive adhesive bonding laminate according to Example 1. A heater-equipped article according to Example 2 was produced in the same manner as in Example 1, except that the heater according to Example 2 was used instead of the heater according to Example 1.

### Example 3

A pressure-sensitive adhesive bonding laminate according to Example 3 was produced in the same manner as in Example 1, except that, in the production of the pressure-sensitive adhesive bonding laminate, a PET film having a thickness of 50 μm was used instead of the PET film having a thickness of 125 μm and the thickness of a second pressure-sensitive adhesive layer was set to 100 μm by adjusting the pressure-sensitive adhesive material. A heater according to Example 3 was produced in the same manner as in Example 1, except that the pressure-sensitive adhesive bonding laminate according to Example 3 was used instead of the pressure-sensitive adhesive bonding laminate according to Example 1. A heater-equipped article according to Example 3 was produced in the same manner as in Example 1, except that the heater according to Example 3 was used instead of the heater according to Example 1.

### Example 4

A pressure-sensitive adhesive bonding laminate according to Example 4 was produced in the same manner as in Example 1, except that, in the production of the pressure-sensitive adhesive bonding laminate, a PEN film having a thickness of 50 μm was used instead of the PET film having a thickness of 125 μm and the thickness of a second pressure-sensitive adhesive layer was set to 100 μm by adjusting the pressure-sensitive adhesive material. A heater according to Example 4 was produced in the same manner as in Example 1, except that the pressure-sensitive adhesive bonding laminate according to Example 4 was used instead of the pressure-sensitive adhesive bonding laminate according to Example 1. A heater-equipped article according to Example 4 was produced in the same manner as in Example 1, except that the heater according to Example 4 was used instead of the heater according to Example 1.

### Example 5

A pressure-sensitive adhesive bonding laminate according to Example 5 was produced in the same manner as in Example 1, except that, in the production of the pressure-sensitive adhesive bonding laminate, a PET film having a thickness of 50 μm was used instead of the PET film having a thickness of 125 μm, the thickness of a first pressure-sensitive adhesive layer was set to 50 μm by adjusting the pressure-sensitive adhesive material, and the thickness of a second pressure-sensitive adhesive layer was set to 100 μm by adjusting the pressure-sensitive adhesive material. A heater according to Example 5 was produced in the same manner as in Example 1, except that the pressure-sensitive adhesive bonding laminate according to Example 5 was used instead of the pressure-sensitive adhesive bonding laminate according to Example 1. A heater-equipped article according to Example 5 was produced in the same manner as in Example 1, except that the heater according to Example 5 was used instead of the heater according to Example 1.

### Example 6

A pressure-sensitive adhesive bonding laminate according to Example 6 was produced in the same manner as in Example 1, except that, in the production of the pressure-sensitive adhesive bonding laminate, a PET film having a thickness of 50 μm was used instead of the PET film having a thickness of 125 μm and the thickness of a second pressure-sensitive adhesive layer was set to 50 μm by adjusting the pressure-sensitive adhesive material. A heater according to Example 6 was produced in the same manner as in Example 1, except that the pressure-sensitive adhesive bonding laminate according to Example 6 was used instead of the pressure-sensitive adhesive bonding laminate according to Example 1. A heater-equipped article according to Example 6 was produced in the same manner as in Example 1, except that the heater according to Example 6 was used instead of the heater according to Example 1.

### Example 7

A pressure-sensitive adhesive bonding laminate according to Example 7 was produced in the same manner as in Example 1, except that, in the production of the pressure-sensitive adhesive bonding laminate, a PET film having a thickness of 50 μm was used instead of the PET film having a thickness of 125 μm and the thickness of a second pressure-sensitive adhesive layer was set to 100 μm by adjusting the pressure-sensitive adhesive material. A heater according to Example 7 was produced in the same manner as in Example 1, except that the pressure-sensitive adhesive bonding laminate according to Example 7 was used instead of the pressure-sensitive adhesive bonding laminate according to Example 1. A first pressure-sensitive adhesive layer of the heater according to Example 7 was pressed against a surface of a stainless plate having a thickness of 1 mm, thereby attaching the heater according to Example 7 to the stainless plate serving as an adherend. In this manner, a heater-equipped article according to Example 7 was obtained.

### Example 8

A pressure-sensitive adhesive bonding laminate according to Example 8 was produced in the same manner as in Example 1, except that, in the production of the pressure-sensitive adhesive bonding laminate, a PET film having a thickness of 50 μm was used instead of the PET film having a thickness of 125 μm and the thickness of a second pressure-sensitive adhesive layer was set to 100 μm by adjusting the pressure-sensitive adhesive material. A heater according to Example 8 was produced in the same manner as in Example 1, except that the pressure-sensitive adhesive bonding laminate according to Example 8 was used instead of the pressure-sensitive adhesive bonding laminate according to Example 1. A first pressure-sensitive adhesive layer of the heater according to Example 8 was pressed against a surface of a polymethyl methacrylate resin (PMMA) plate having a thickness of 2 mm, thereby attaching the heater according to Example 8 to the PMMA plate serving as an adherend. In this manner, a heater-equipped article according to Example 8 was obtained.

### Comparative Example 1

A film provided with a conductive metal oxide layer and having a pair of power supply electrodes formed thereon was prepared in the same manner as in Example 1, and a pressure-sensitive adhesive layer was formed by applying a pressure-sensitive adhesive material (Nitto Denko Corporation, product name: LUCIACS) to a principal surface of the film on the side opposite to the conductive metal oxide layer. The thickness of the pressure-sensitive adhesive layer was set to 100 μm by adjusting the pressure-sensitive adhesive material. In this manner, a heater according to Comparative Example 1 was obtained. The pressure-sensitive adhesive layer of the heater according to Comparative Example 1 was pressed against a surface of a polycarbonate (PC) plate having a thickness of 2 mm, thereby attaching the heater according to Comparative Example 1 to the PC plate serving as an adherend. In this manner, a heater-equipped article according to Comparative Example 1 was obtained.

### Comparative Example 2

A heater according to Comparative Example 2 was produced in the same manner as in Comparative Example 1, except that the thickness of a pressure-sensitive adhesive layer was set to 200 μm by adjusting the pressure-sensitive adhesive material. A heater-equipped article according to Comparative Example 2 was produced in the same manner as in Comparative Example 1, except that the heater according to Comparative Example 2 was used instead of the heater according to Comparative Example 1.

As can be seen from Table 1, the results of the reliability evaluation for the heater-equipped articles according to the examples show that the heat-generating layers did not fracture. These results suggest that, in the heater according to each of the examples, the heat-generating layer is unlikely to fracture even if expansion or contraction of an adherend is caused by a change in environmental conditions. These results also suggest that the heater according to each of the examples is unlikely to peel off even under high temperature and high humidity environmental conditions. On the other hand, the result of the reliability evaluation for the heater-equipped article according to Comparative Example 1 suggests that, although the heater according to Comparative Example 1 is unlikely to peel off even under high temperature and high humidity environmental conditions, the heat-generating layer of the heater according to Comparative Example 1 is likely to fracture when an adherend expands or contracts owing to a change in environmental conditions. According to the result of the reliability evaluation for the heater-equipped article according to Comparative Example 2, the heater according to Comparative Example 2 is likely to peel off under high temperature and high humidity environmental conditions. It is speculated that the large thickness of the pressure-sensitive adhesive layer causes the heater according to Comparative Example 2 to be likely to peel off.

TABLE 1

| | First | Second | Support for pressure-sensitive | | | | |
|---|---|---|---|---|---|---|---|
| | pressure-sensitive | pressure-sensitive | adhesive layers | | | | |
| | adhesive layer | adhesive layer | | | In-plane | | |
| | Thickness | Thickness | | Thickness | dimensional | Adherend | Evaluation of |
| | [μm] | [μm] | Material | [μm] | change rate [%] | Material | reliability |
| Ex. 1 | 100 | 150 | PET | 125 | 0.35 | PC | A |
| Ex. 2 | 100 | 100 | PET | 125 | 0.35 | PC | A |
| Ex. 3 | 100 | 100 | PET | 50 | 0.35 | PC | A |
| Ex. 4 | 100 | 100 | PEN | 50 | 0.15 | PC | A |
| Ex. 5 | 50 | 100 | PET | 50 | 0.35 | PC | A |
| Ex. 6 | 100 | 50 | PET | 50 | 0.35 | PC | A |
| Ex. 7 | 100 | 100 | PET | 50 | 0.35 | SUS | A |
| Ex. 8 | 100 | 100 | PET | 50 | 0.35 | PMMA | A |
| Comp. | 100 | — | — | — | — | PC | Y |
| Ex. 1 | | | | | | | |
| Comp. | 200 | — | — | — | — | PC | X |
| Ex. 2 | | | | | | | |

1. A heater comprising:
a substrate that is formed of an organic polymer;
a heat-generating layer that is disposed in contact with the substrate in a thickness direction of the substrate, the heat-generating layer being a conductive metal oxide layer;
a pair of power supply electrodes that are electrically connected to the heat-generating layer; and
a pressure-sensitive adhesive bonding laminate that has a pressure-sensitive adhesive surface used for pressure-sensitive adhesive bonding with an adherend and in which a plurality of pressure-sensitive adhesive layers and at least one support for the plurality of pressure-sensitive adhesive layers are alternately laminated between the pressure-sensitive adhesive surface and the heat-generating layer in the thickness direction of the substrate.

2. The heater according to claim 1, wherein
the plurality of pressure-sensitive adhesive layers include a first pressure-sensitive adhesive layer that forms the pressure-sensitive adhesive surface, and
the first pressure-sensitive adhesive layer has a thickness of 150 μm or less.

3. The heater according to claim 1, wherein
the plurality of pressure-sensitive adhesive layers include at least one second pressure-sensitive adhesive layer that is disposed spaced apart from the pressure-sensitive adhesive surface in the thickness direction of the substrate,
the second pressure-sensitive adhesive layer has a thickness of 25 μm or more, and
the sum of thicknesses of the plurality of pressure-sensitive adhesive layers is 150 μm or more.

4. The heater according to claim 1, wherein
an in-plane dimensional change rate Rs represented by the following formula (1) of the support is 1.0% or less:
In-plane dimensional change rate Rs=100×|S_{80,80}−S_{25,50}|/S_{25,50} (1)
where S_{25,50} denotes an in-plane dimension of the support in an environment at 25° C. with a relative humidity of 50%, and
S_{80,80} denotes an in-plane dimension of the support in an environment at 80° C. with a relative humidity of 80%.

5. The heater according to claim 1, wherein the support has a thickness of 25 μm or more.

6. The heater according to claim 1, wherein the pressure-sensitive adhesive bonding laminate has a thickness of 1 mm or less.

7. The heater according to claim 1, wherein the conductive metal oxide layer is a crystalline film and has a thickness of 20 nm or more.

8. The heater according to claim 1, wherein the pair of power supply electrodes contain a metal as a main component and have a thickness of 1 or more.

9. The heater according to claim 1, having an average transmittance of 70% or more for light having a wavelength from 400 to 1200 nm.

10. A heater-equipped article comprising:
an adherend; and
the heater according to claim 1, the heater being attached to the adherend with the pressure-sensitive adhesive surface being in contact with the adherend.
